(19) United States
(12) Patent Application Publication
(10) Pub. No.: US 2022/0159420 A1
(43) Pub. Date: May 19, 2022

(54) Scheduled Texting App

(71) Applicant: Conor Egge, Pelican Rapids, MN (US)

(72) Inventor: Conor Egge, Pelican Rapids, MN (US)

(21) Appl. No.: 17/099,370

(22) Filed: Nov. 16, 2020

(51) Int. Cl. H04W 4/12; H04W 72/12; H04W 4/06

(52) U.S. Cl. CPC H04W 4/12; H04W 4/06; H04W 72/1278

(57) ABSTRACT

The scheduled texting app is an application intended for smart phones or other such devices, that is capable of creating messages that will be sent to the recipient upon a specified trigger event. Two such trigger events provided for by the app are time triggers and location triggers. Time triggers are considered when the specified time and date are reached. The user could therefore utilize this capacity and anticipate a desired response to a future event, such as a celebratory message at an anniversary. Location triggers are considered when the user reaches a physical location or is within a specified distance from such. This functionality could be especially practical for notifying another when a particular landmark is reached, or indicating another when the user has arrived to the other's location.

### BACKGROUND

Text messaging, or texting, is the act of composing and sending electronic messages, typically consisting of alphabetic and numeric characters, between two or more users of mobile devices, desktops/laptops, or other type of compatible computer. Text messages may be sent over a cellular network, or may also be sent via an Internet connection. Text messages are used for personal, family, business and social purposes. Governmental and non-governmental organizations use text messaging for communication between colleagues. This makes texting a quick and easy way to communicate with friends, family and colleagues, including in contexts where a call would be impolite or inappropriate. There have been no products available as original equipment or as an aftermarket to address this problem.

Group texts involve more than two users. In some cases, when one or more people on the group text are offline, in airplane mode, or has their device shut down, a text being sent to the group may reveal an error message that the text did not go through. Users should rest assured, that all online or available users on the group received the message and that re-sending the message will only result in some participants receiving the message multiple times. There have been no products available as original equipment or as an aftermarket to address this problem either.

There exists a need for a delayed text message sending app that is not being met by any known or disclosed device or system of present.

### SUMMARY OF THE INVENTION

The scheduled texting app is an application intended for smart phones or other such devices, that is capable of creating messages that will be sent to the recipient upon a specified trigger event. Two such trigger events provided for by the app are time triggers and location triggers. Time triggers are considered when the specified time and date are reached. The user could therefore utilize this capacity and anticipate a desired response to a future event, such as a celebratory message at an anniversary. Location triggers are considered when the user reaches a physical location or is within a specified distance from such. This functionality could be especially practical for notifying another when a particular landmark is reached, or indicating another when the user has arrived to the other's location.

### BRIEF DESCRIPTION OF THE DRAWINGS

FIG. 1 is a flow chart depicting the various distinct app states in accordance with an embodiment of the present disclosure.

FIG. 2 is a flow chart of limitations of the scheduled texting app in accordance with an embodiment of the present disclosure.

FIG. 3 is a block diagram of modules and circuit components of the temporally and spatially triggered application in accordance with an embodiment of the present disclosure.

Throughout the description, similar reference numbers may be used to identify similar elements depicted in multiple embodiments. Although specific embodiments of the invention have been described and illustrated, the invention is not to be limited to the specific forms or arrangements of parts so described and illustrated. The scope of the invention is to be defined by the claims appended hereto and their equivalents.

### DETAILED DESCRIPTION

Reference will now be made to exemplary embodiments illustrated in the drawings and specific language will be used herein to describe the same. It will nevertheless be understood that no limitation of the scope of the disclosure is thereby intended. Alterations and further modifications of the inventive features illustrated herein and additional applications of the principles of the inventions as illustrated herein, which would occur to one skilled in the relevant art and having possession of this disclosure, are to be considered within the scope of the invention.

Throughout the present disclosure the term [term] is used to refer to [describe, rest of sentence]. The term [term] refers to [describe, rest of sentence].

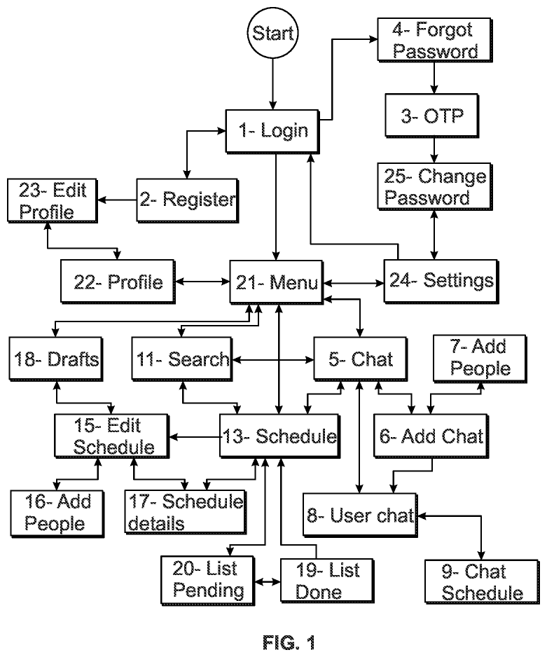

FIG. 1 is a flow chart depicting the various distinct app states in accordance with an embodiment of the present disclosure. App functioning begins at the login page 1. Here the user may enter their credentials, which brings them to the menu 21, they can register a new account 2, or can reset the password in the case that it was forgotten 4. In that case, a one-time password is sent and the user is prompted to reset their password 25. Users can also change their password once logged in by going to said option under settings 24. On the settings page, which can be accessed directly from the menu, the user may also log out, taking them to the original login page. From the menu, the user may also access their profile screen 22, which can be edited 23. This is similar to when the user first creates their account, in that they are sent to the edit profile page, from which they can view their profile and go to the menu.

From the menu, the user can access a variety of other tasks, such as the chat list page 5, the schedule page 13, the drafts page 18, and the search page 11. On the search page, the user may search for saved contacts. On the drafts page, the user may view and edit unfinished scheduled messages. On the chat page, the user may see a list of different conversations. A conversation can be selected, or a new conversation can be created 6, and contacts can be selected 7 to be included in the new conversation. Once all the intended contacts have been added and an initial chat is sent, the user may continue to the heretofore mentioned chat page. On that chat page, a message can be scheduled for that conversation 9. All scheduled messages for that conversation will be displayed as such on the chat page. The schedule page shows a calendar with the scheduled messages shown thereon. An individual message may be selected 17, a new message may be scheduled 15, or the view can be changed to a list of scheduled messages 20, or messages already sent 19. When an individual message is under editing, new contacts may be added as recipients 16, or the unfinished message may be saved to drafts. Once the message is finished being edited or canceled, the user returns to the message selection page.

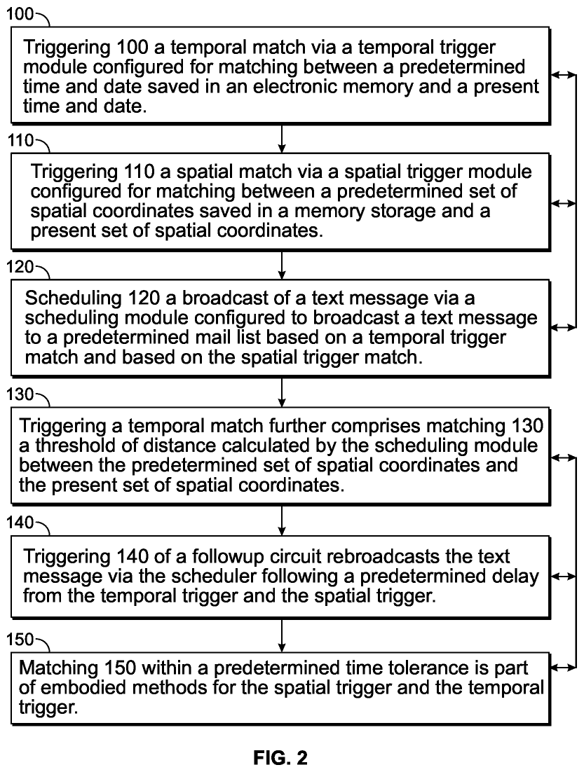

FIG. 2 is a flow chart of limitations of the scheduled texting app in accordance with an embodiment of the present disclosure. The method includes triggering 100 a temporal match via a temporal trigger module configured for matching between a predetermined time and date saved in an electronic memory and a present time and date. The method also includes triggering 110 a spatial match via a spatial trigger module configured for matching between a predetermined set of spatial coordinates saved in a memory storage and a present set of spatial coordinates. The method additionally includes scheduling 120 a broadcast of a text message via a scheduling module configured to broadcast a text message to a predetermined mail list based on a temporal trigger match and based on the spatial trigger match.

Embodiments of the method further comprise setting the predetermined set of spatial coordinates to a GPS (global positioning satellite) set of spatial coordinates. Triggering a temporal match further comprises matching 130 a threshold of distance calculated by the scheduling module between the predetermined set of spatial coordinates and the present set of spatial coordinates. The predetermined the set of spatial coordinates to include a list of places associated with future travel plans, natural and man made monuments, buildings, and GPS coordinates. The predetermined time and date include fractional seconds, minutes, hours, days, months and years.

Furthermore, embodiments of the method include predetermining a delay between a temporal trigger match and a spatial trigger match and a broadcast of the text message. Embodiments of the method further include displaying a page including a plurality of texts scheduled per the predetermined time and the predetermined date. Also, the embodied method includes displaying a page including a plurality of broadcast texts, a plurality of unbroadcast texts and associated temporal and spatial triggers.

A triggering 140 of a followup circuit rebroadcasts the text message via the scheduler following a predetermined delay from the temporal trigger and the spatial trigger. Additionally, matching 150 within a predetermined time tolerance is part of embodied methods for the spatial trigger and the temporal trigger.

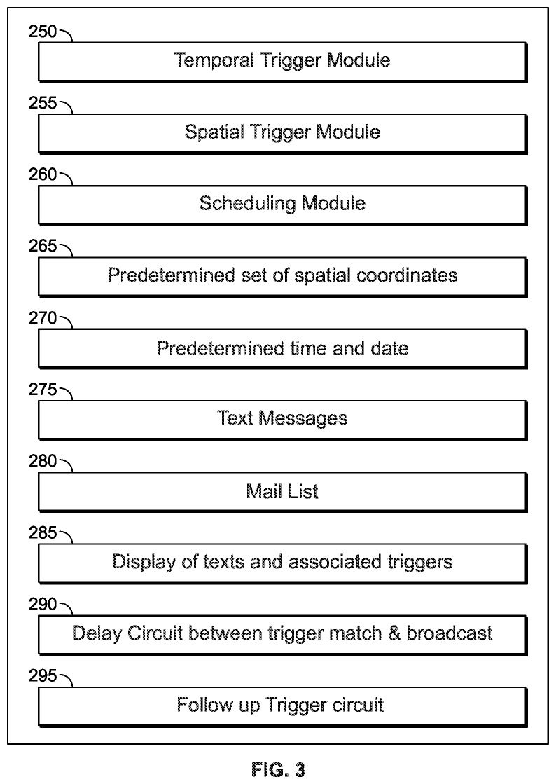

FIG. 3 is a block diagram of modules and circuit components of the temporally and spatially triggered application in accordance with an embodiment of the present disclosure. The block diagram includes the temporal trigger module 250, the spatial trigger module 255, the scheduling module 260, the predetermined set of spatial coordinates 265, the predetermined time and date 270, the text messages 275, the mail list 280, the display of texts and associated triggers 285, the delay circuit between trigger match and broadcast 290 and the follow up trigger circuit 295.

User Registration: Type of Users- End Users, and Admin Users can type a text in the application. They can either send the text immediately or they can schedule the text to be sent later. If user schedule the text for some later time, they will view a dynamic calendar in which they can set the date and time on which the text will be automatically sent by the system. Users will also enter the recipient name and number to which the message is to be sent. Users will be also able to cancel the text before it is sent if they want. Users will be able to view the complete details of number of messages they sent in the past, along with date, time and recipient of the same. Users will be able to view the scheduled messages to be sent in future. Users will be able to view the messages received by them. User will able to go in ‘drafts messages’ option which will have all the created messages which are set to send. User will be able to stop it from sending if required. User can go back in ‘drafts messages’ option and change the time and date and reschedule it as per requirement. User will have the option to go ‘drafts message’ and can edit the content of the message before sending it. User can set a message to send when they arrive at a location or address set by the user on using the GPS of the phone, provided the GPS is turned on. Admin will be able to manage the complete system from the backend. Admin can edit/update/delete the user details from the backend. Admin will be able to search users & view the detail information on them. Admin can check about every user messaging history. Admin will be able to set the time limit up to which user can schedule the 4 text. Admin can set the limit as 2 weeks, 4 weeks as per their choice. Admin can view all text messages that has been sent & scheduled in the system. Admin can view the messaging summary on daily, weekly & monthly basis. Admin can view the no of messages sent & scheduled by an individual user.

Designing of the entire App screens for User app & Beautician/Runner app in PSD format considering the workflow shared. Navigation of the Application—The entire workflow shared would be accessible as an actual App with the static data, no connectivity with the backend. User Management—User registration and Login, Login, change password, forgot password, edit profile Admin will be able to view the users from Back end. Write a Text 1. Users can type a text in the application. Users will have 2 options. They can either send the text immediately or they can schedule the text to be sent later. If user schedule the text for some later time, they will view a dynamic calendar in which they can set the date and time on which the text will be automatically sent by the system. Users will also enter the recipient name and number to which the message is to be sent. Users will be also able to cancel the text before it is sent if they want. Drafts Messages User will able to go in ‘drafts messages’ option which will have all the created messages which are set to send. User will be able to stop it from sending if required. User can go back in ‘drafts messages’ option and change the time and date and reschedule it as per requirement. User will have the option to go ‘drafts message’ and can edit the content of the message before sending it. User can set a message to send when they arrive at a location or address set by the user on using the GPS of the phone, provided the GPS is turned on. Statistics Users will be able to view the complete details of number of messages they sent in the past, along with date, time and recipient of the same. Users will be able to view the scheduled messages to be sent in future. Users will be able to view the messages received by them. Admin Analytics and report Weekly, monthly. My Requests, Join us form, static pages; settings & Final Testing of the application.

Users can type a text in the application. Users will have 2 options. They can either send the text immediately or they can schedule the text to be sent later. If user schedule the text for some later time, they will view a dynamic calendar in which they can set the date and time on which the text will be automatically sent by the system. Users will also enter the recipient name and number to which the message is to be sent. Users will be also able to cancel the text before it is sent if they want. User will be able to pick one or more recipients to send the message or images. Drafts Messages: User will able to go in ‘drafts messages’ option which will have all the created messages which are set to send. User will be able to stop it from sending if required. User can go back in ‘drafts messages’ option and change the time and date and reschedule it as per requirement. User will have the option to go ‘drafts message’ and can edit the content of the message before it sends example (if one has typed in to be somewhere at 2 pm and a day later, he or she can change it to 3 pm you have the option to do that). User can set a message to send when they arrive at a location or address set by the user on using the GPS of the phone, provided the GPS is turned on. Statistics:Users will be able to view the complete details of number of messages they sent in the past, along with date, time and recipient of the same. Users will be able to view the scheduled messages to be sent in the future. Users will be able to view the messages received by them.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

While the forgoing examples are illustrative of the principles of the present disclosure in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the disclosure be limited, except as by the specification and claims set forth herein.

What is claimed is:

1. A device for scheduling texts, the device comprising:
a temporal trigger module comprising a predetermined time and a predetermined date saved in a memory storage for a constant match comparison with a present time and a present date;
a spatial trigger module comprising a predetermined set of spatial coordinates saved in a memory storage for a constant match comparison with a present set of spatial coordinates; and
a scheduling module configured to broadcast a text message to a predetermined mail list based on a temporal trigger match and based on the spatial trigger match.

2. The device of claim 1, wherein the predetermined set of spatial coordinates comprise a GPS (global positioning satellite) set of spatial coordinates.

3. The device of claim 1, wherein the constant match comparison comprises a threshold of distance calculated by the scheduling module between the predetermined set of spatial coordinates and the present set of spatial coordinates.

4. The device of claim 1, wherein the predetermined set of spatial coordinates comprises a list of places associated with future travel plans, natural and man made monuments, buildings, and GPS coordinates.

5. The device of claim 1, wherein the predetermined time and date comprises fractional seconds, minutes, hours, days, months and years.

6. The device of claim 1, further comprising a predetermined delay circuit between a temporal trigger match and a spatial trigger match and a broadcast of the text message.

7. The device of claim 1, further comprising a display page of a plurality of texts scheduled per the predetermined time and the predetermined date.

8. The device of claim 1, further comprising a display page of a plurality of broadcast texts, and a plurality of unbroadcast texts and associated temporal and spatial triggers.

9. The device of claim 1, further comprising a followup trigger circuit configured to rebroadcast via text message via the scheduler following a predetermined delay from the temporal trigger and the spatial trigger.

10. The device of claim 1, wherein the temporal trigger is matched within a predetermined time tolerance and the spatial trigger is matched within a predetermined spatial tolerance.

11. A method for scheduling a text message, the method comprising:
triggering a temporal match via a temporal trigger module configured for matching between a predetermined time and date saved in an electronic memory and a present time and date;
triggering a spatial match via a spatial trigger module configured for matching between a predetermined set of spatial coordinates saved in a memory storage and a present set of spatial coordinates; and
scheduling a broadcast of a text message via a scheduling module configured to broadcast a text message to a predetermined mail list based on a temporal trigger match and based on the spatial trigger match.

12. The method of claim 11, further comprising setting the predetermined set of spatial coordinates to a GPS (global positioning satellite) set of spatial coordinates.

13. The method of claim 11, wherein triggering a temporal match further comprises matching a threshold of distance calculated by the scheduling module between the predetermined set of spatial coordinates and the present set of spatial coordinates.

14. The method of claim 11, further comprising predetermining the set of spatial coordinates to include a list of places associated with future travel plans, natural and man made monuments, buildings, and GPS coordinates.

15. The method of claim 11, further comprising predetermining the time and date to include fractional seconds, minutes, hours, days, months and years.

16. The method of claim 11, further comprising predetermining a delay between a temporal trigger match and a spatial trigger match and a broadcast of the text message.

17. The method of claim 11, further comprising displaying a page including a plurality of texts scheduled per the predetermined time and the predetermined date.

18. The method of claim 11, further comprising displaying a page including a plurality of broadcast texts, a plurality of unbroadcast texts and associated temporal and spatial triggers.

19. The method of claim 11, further comprising triggering a followup circuit configured to rebroadcast the text message via the scheduler following a predetermined delay from the temporal trigger and the spatial trigger.

20. The method of claim 11, further comprising matching within a predetermined time tolerance the spatial trigger and the temporal trigger.
